(19) United States
(12) Patent Application Publication
(10) Pub. No.: US 2006/0187050 A1
(43) Pub. Date: Aug. 24, 2006

(54) Loop antenna for RFID

(75) Inventor: James Daniel Wagner, Tangent, OR (US)

Correspondence Address: PSC SCANNING, INC. - STOEL RIVES LLP;C/O STOEL RIVES LLP, 900 SW 5TH AVENUE, SUITE 2600, PORTLAND, OR, 97204, US

(73) Assignee: PSC Scanning, Inc., Eugene, OR (US)

(21) Appl. No.: 11/055,886

(22) Filed: Feb. 11, 2005

(51) Int. Cl. G08B 13/14

(52) U.S. Cl. 340/572.7

(57) ABSTRACT

There is a data reader includes a housing, a radio frequency identification (RFID interrogator for detecting various amounts of data and processing circuitry connected to an output of the RFID interrogator. The data reader further includes a communications unit connected to the output with a loop antenna connected to the communications unit. The loop directional antenna provides gain and directionality when transmitting and receiving an electromagnetic signal. There is a multiple technology data reader includes an optical data reader having a housing, a photosensitive detector within the housing, and an optical collector for directing light onto the photosensitive detector. Processing circuitry is connected to an output of the photosensitive detector. In addition, the multiple technology data reader has radio frequency identification (RFID) interrogator for detecting data. There is a computer but connected to a communications unit, wherein the communications unit is connected to the optical data reader and the RFID interrogator. A loop directional antenna means is connected to the communication unit providing gain and directionality when transmitting and receiving a communications signal.

### TECHNICAL FIELD

The field of the present disclosure relates to wireless transmitting systems and, in more particular, to RFID systems that use a loop antenna to transmit or receive wireless signals.

### BACKGROUND

Radio Frequency Identification (RFID) transponders or tags are operated in conjunction with RFID interrogators for a variety of inventory-control, data collection and other purposes. An item having a tag associated with it is brought into a read-zone established by the interrogator. The RFID interrogator generates a modulated electromagnetic signal at a carrier frequency. The modulated signal, which carries information, communicates this information at a rate that is lower than the carrier frequency. The RFID interrogator transmits an interrogating RF signal, which is re-modulated by a receiving tag in order to impart information stored within the tag to the signal. The receiving tag then transmits the re-modulated answering RF signal to the interrogator.

In RFID transponders, antennas connected to the front-end and the rest of the RFID circuit need to produce a front-end output voltage that is above some threshold voltage in order to power the RFID circuit. This is accomplished within the front-end of the RFID circuit. These circuits use diodes and capacitors that rectify the radio frequency (RF) carrier component of the modulated electromagnetic field, which excites the antenna leaving the modulated signal at the output of the front-end.

In RFID applications, the antenna/front-end combination has to produce a minimum output voltage to power the chip, and to provide sufficient power collected from the electromagnetic field to provide current to operate the RFID circuit. Consequently, when the voltage and/or power requirements of the RFID circuit are not fulfilled, the circuit will not operate. If the received signal strength is not optimal, the distance over which it can operate is reduced.

In prior art, such as that described in U.S. Pat. No. 6,720,930 B2, issued to Johnson et al., entitled “Omnidirectional RFID Antenna,” a pair of coils are arranged in a crossing pattern in parallel and in phase. The radiation pattern is omni-directional generated by each antenna leg, wherein 5 null-zones are created. An RFID tag is not readable within the null zones.

In U.S. Pat. No. 6,696,954 B2, issued to Chung, entitled “Antenna Array For Smart RFID Tags,” several antenna loops define a detection region for electromagnetic signals. An RFID tag is not readable outside the detection region.

What is needed in RFID systems is an antenna that improves directionality and gain to provide the required voltage and/or power for the RFID circuit and achieving this increased gain and directionality at a low cost.

### SUMMARY

It is an aspect of the preferred embodiment to provide an improved antenna system on RFID reader and transponder or tag applications.

It is another aspect of the preferred embodiment to provide an improved antenna system on RFID reader and tag applications that is low in weight and cost.

It is yet another aspect of the preferred embodiment to provide an antenna system on RFID reader and tag applications improving directionality and gain.

It is yet still another aspect of the preferred embodiment to provide an antenna system on RFID reader and tag applications allowing the reader to look down the centerline of the antenna.

It is still yet another aspect of the preferred embodiment to provide an antenna system on RFID reader and tag applications allowing generation of two independent polarization planes at right angles to each other.

In the preferred embodiment there is a data reader which includes a housing, a radio frequency identification (RFID) interrogator for detecting data and processing circuitry connected to an output of the RFID interrogator. The data reader further includes a communications unit connected to the output with a directional antenna means connected to the communications unit. The loop antenna provides gain and directionality when transmitting and receiving an electromagnetic signal.

In another preferred embodiment there is a multiple technology data reader which includes an optical data reader including a housing, a photosensitive detector within the housing, and an optical collector for directing light onto the photosensitive detector. Processing circuitry is connected to an output of the photosensitive detector. In addition, the multiple technology data reader has radio frequency identification (RFID) interrogator for detecting data. There is a computer connected to a communications unit, wherein the communications unit is connected to the optical data reader and the RFID interrogator. A loop antenna means is connected to the communication unit providing gain and directionality when transmitting and receiving communication signals.

These and other aspects of the disclosure will become apparent from the following description, the description being used to illustrate a preferred embodiment when read in conjunction with the accompanying drawings.

### BRIEF DESCRIPTION OF THE DRAWINGS

FIG. 1 is a functional block diagram of a multiple technology data reader with a loop directional antenna, according to a preferred embodiment.

FIG. 2 is a functional block diagram of a data reader with a loop directional antenna, according to an embodiment.

FIG. 3 illustrates a circuit diagram with a loop directional antenna for a multiple technology data reader, according to a preferred embodiment.

FIG. 4 is a block diagram of a radio frequency transmitter communicating an RF signal to a receiver, according to an embodiment.

FIG. 5A is a drawing of the loop directional antenna, according to an embodiment.

FIG. 5B is a drawing of the loop directional antenna, according to an embodiment.

FIG. 6 is a partial drawing of a hand-held apparatus utilizing a loop directional antenna, according to an embodiment.

FIG. 7 is an isometric drawing of a hand-held apparatus utilizing a loop directional antenna, according to an embodiment.

### DETAILED DESCRIPTION OF THE DISCLOSURE

While the preferred embodiments are described below with reference to a RFID interrogator, a practitioner in the art will recognize the principles described herein are viable to other applications.

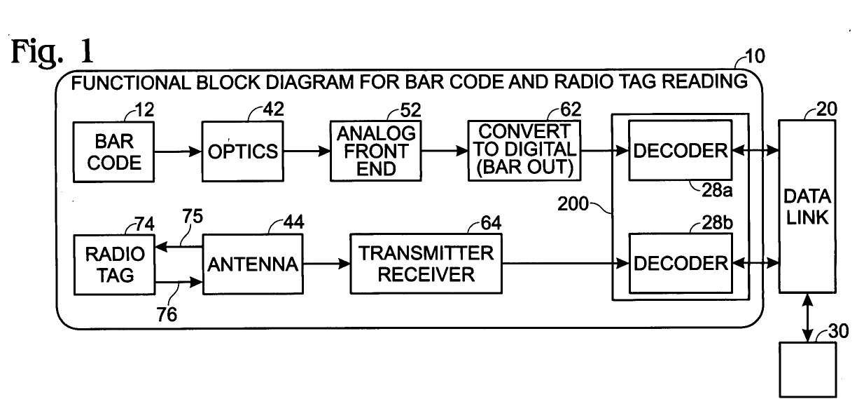

FIG. 1 is a functional block diagram of a multiple technology data reader 10, which can read a bar code 72 or an RFID transponder 74. The bar code 72 is read and detected by an optical means 42, which sends the detected signal to an analog front end means 52. The analog signal is then converted to a digital signal by a conversion to digital means 62. The converted signal is decoded by a bar code decoder 28a and then sent to a host computer 30 via a link 20. The multiple technology reader as described in U.S. Pat. No. 6,415,978, issued to McAllister, entitled “Multiple Technology Data Reader For Bar Code Labels And RFID Tags,” the entire contents of said patent are incorporated herein by reference and made part of this disclosure. This reader may use the principles of the preferred embodiment as described in this disclosure.

The RFID transponder (tag) 74 is detected by an antenna 44. The antenna radiates an electromagnetic signal 75 and detects a response signal 76 from the RFID tag 74. The response signal 76 is sent to an RFID transmitter/receiver 64. The response signal 76 is then decoded by an RFID decoder 28b and then sent to a host computer 30 via the link 20.

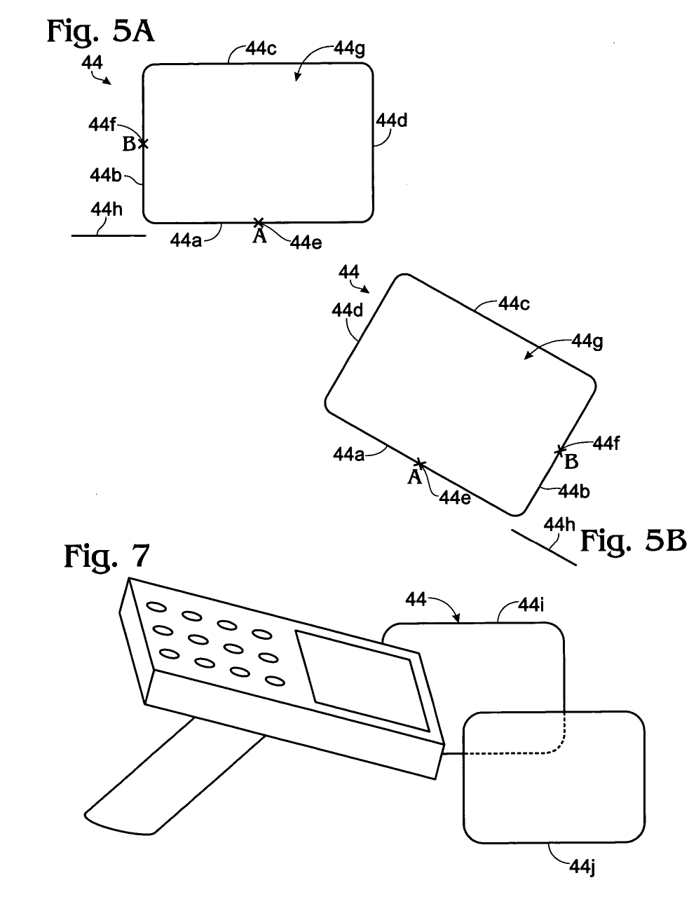

The loop directional antenna means 44, as shown in FIGS. 5A and 5B, are a polarized antenna arrangement in the preferred embodiment of the invention. The polarized antenna 44 includes a first element 44a, in communication with a second element 44b, in communication with a third element 44c and in communication with a fourth element 44d. The elements 44a, 44b, 44c and 44d communicate in such a way as to form a square or loop. The combination of these elements creates a desired field distribution. If location 44e is driven, the radiated field is horizontally polarized. Likewise, when location 44f is driven, the radiated field is vertically polarized. Depending on a design, numerous field distributions are attainable by the use of differing lengths of each element, and by changing the location that is driven in a “grounded plane.” The directional antenna 44 uses the plane 44g as “ground plane.”

The loop directional antenna means 44 has significant gain. The optimal loop is nearly square, and is very close to ½ wavelength at each element 44a, 44b, 44c and 44d. This gain results because the opposite elements 44a, 44c and 44b, 44d radiate with the result almost equivalent to two dipoles that are ½ wavelength apart. The loop directional antenna means 44 uses a connector and is driven at either location 44e or location 44f and transmission line 44h connects to either location 44e or 44f with a transmitter/receiver (not shown). The loop directional antenna means 44 can be formed on single sheets of flexible material using circuit board fabrication techniques widely known by practitioners in the art.

In another embodiment as shown in FIG. 7, the loop directional antenna means 44 consists of a driven element 44i and a reflector 44j which is slightly longer than the driven element. The reflector 44j is positioned at a right angle to the driven element 44i that will produce waves that are polarized in planes that are 90° apart. This arrangement produces waves that are polarized in the plane of the elements thus providing improved gain and directionality. As is known to the practitioner in the art, the driven element orientation and reflector orientation may be positioned at any angle relative to one another, providing various polarized planes, producing the desired gain and directionality of the loop antenna 44.

The driven element may be driven in the middle of any first element 44a, second element 44b, third element 44c and fourth element 44d. When this happens, the driven element and the opposite element are the primary radiators and define the plane of polarization. For example, if the first element 44a is driven at location 44e, the opposite element 44c together with the first element 44a, are the primary radiators' defining the polarization of the antenna wave. A second driven-point may be added to the middle of either the second element 44b or fourth element 44d, providing a polarization at right angles to that produced when only the first element 44a is driven. The two elements can be independently driven for linear polarization in two planes or, together, after proper phasing, to produce circular polarization. This arrangement produces waves that are polarized in the driven plane(s) of the elements thus providing improved gain and directionality. Therefore, multiple polarizations are possible without adding additional elements to the antenna.

In FIGS. 1, 2, 3, 4 and 6 the open center of the loop antenna 44 can look right down the center of the antenna providing user ease of operation. In addition, the RFID reader circuitry can be added into the center of antenna 44. The RFID reader and loop antenna may share space providing an RFID reader arrangement occupying a smaller volume. Alternately, in this arrangement the loop antenna 44 may take the form of fins or disks extending outward from the reader.

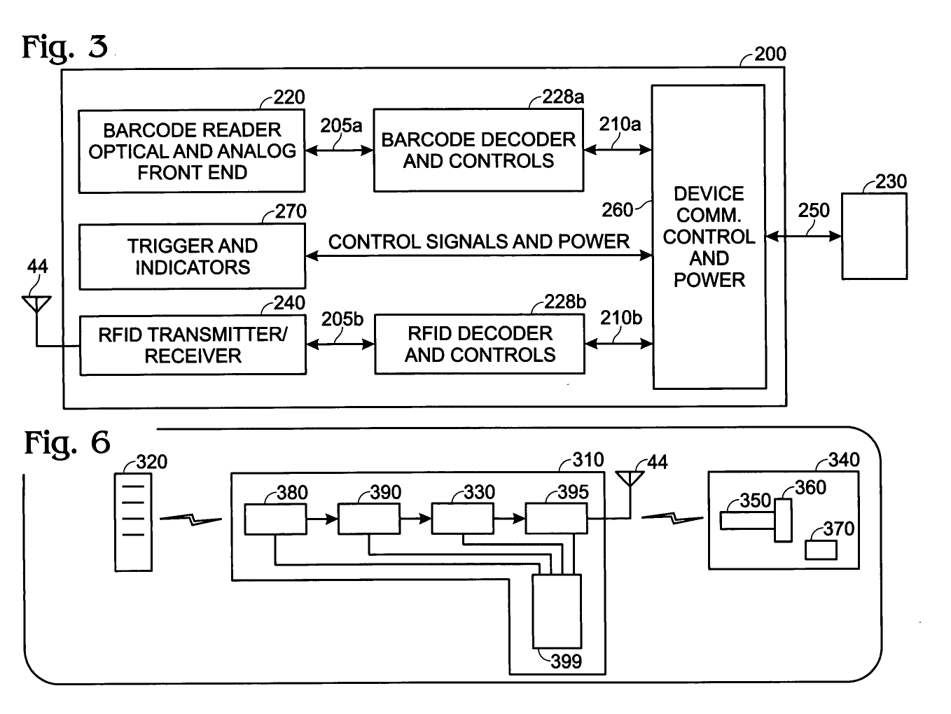

In a preferred embodiment as shown in FIG. 3, the multiple technology data reader 200 includes the optical and analog front end components of a bar code reader 220. They are connected to a barcode decoder and controller 228a. In addition, the data reader includes the loop antenna 44 (FIG. 5), transmitter and receiver components of an RFID interrogator 240, which are connected to a RFID decoder and controller 228b. The decoder and control units 228a and 228b are connected to a device communications, control and power unit 260. The multiple technology data reader 200 also includes a trigger unit 270, which sends and receives control signals and power, both to and from the device communications, control and power unit 260. The device communications, control and power unit 260 is connected to a host computer 230 via link 250.

The barcode decoder and control unit 228a has a control and data link 210a, which enables the device communications, control and power unit 260 to initialize and configure the barcode decoder and control unit 228a. Furthermore, the bar code decoder and control unit 228a uses the control and data link 210a to send data to the device communications, control and power unit 260 or receive data from the device communications, control and power unit 260. Data can be sent in either direction between the barcode decoder and control unit 228a and the barcode reader subsystem 220 via a serial communications line 205a.

Likewise, the RFID decoder and control unit 228b has a control and data link 210b, which enables the device communications, control and power unit 260 to initialize and configure the RFID decoder and control unit 228b. In addition, the control unit and data link 210b allows the RFID decoder and control unit 228b to send data to the device communications, control and power unit 260 or receive data from the device communications, control and power unit 260. Data is sendable, in either direction, between the RFID decode control unit 228b and the barcode reader subsystem 240 via a serial communications line 205b.

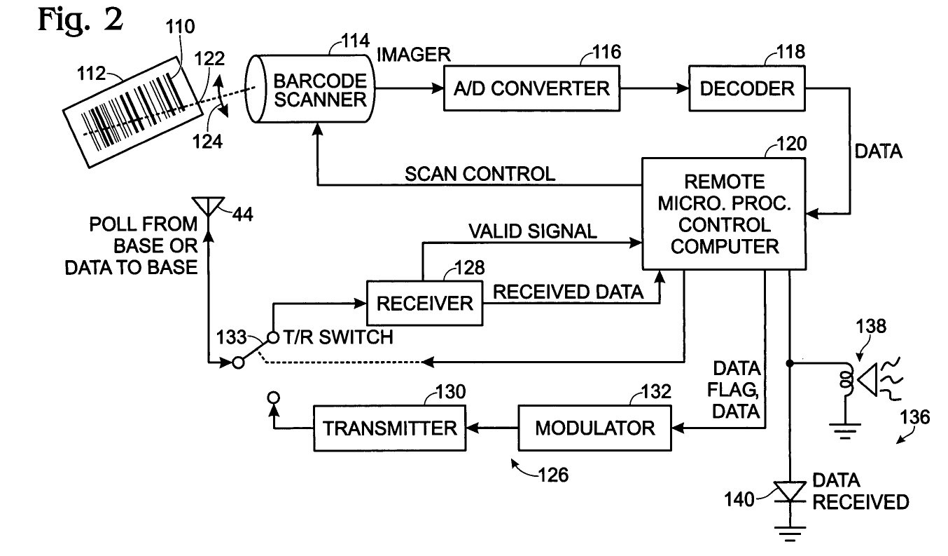

In FIG. 2, there is shown a typical bar code reader 110 on a label 112, which may be attached to an item and identifies that item through the optical axis 122. The data representing the item is obtained by a terminal such as a bar code scanner 114. The scanner 114 provides bar code image signals which are digitized as by an analog to digital converter 116. Also, bar code scanner 114 provides bar code image signals by the digitizer circuit as described in U.S. Pat. No. 5,864,129, issued to Boyd, entitled “Bar Code Digitizer Including Voltage Comparator,” the entire contents of said patent are incorporated herein by reference and made part of this disclosure. This reader may use the principals of the preferred embodiment as described in this disclosure. The digitized signal is coded in a decoder 118 to provide serial binary data representing the bar code. This data is inputted into a microprocessor controller 120 in the remote unit. The controller 120 exercises several functions. These functions include, but are not limited to, a scan control signal generation for enabling the bar code imager to scan across the code 110 in the direction of the arrow 124, when the label 112 comes into proximity of the scanner.

The wireless radio communications features are provided by a transceiver 126 including a receiver 128, a transmitter 130 and modulator 132. The transmitter and modulator provide transmission where a carrier is moved between states, according to different binary bits of a message. For example, the output frequency in an embodiment of the invention may be in the ultra-high frequency (UHF) band, in the very high frequency (VHF) band or other bands at a relatively low power. In typical applications such as in warehouses and factories, low power transmitters are sufficient to cover a large enough area for remote collection of data from bar code scanners.

The receiver 128 operates at the same frequency as the transmitter 130. The receiver 128 and the transmitter 130 are connected to a loop antenna 44 (FIG. 5) using a transmit-receive (T/R) switch 133, which is controlled by a control signal from the computer 120. This wireless collection of data is described in U.S. Pat. No. 5,581,707, issued to Kuecken, entitled “System For Wireless Collection O Data From A Plurality Of Remote Data Collection Units Such As Portable Bar Code Readers,” the entire contents of said patent are incorporated herein by reference and made part of this disclosure. This reader may use the principles of the preferred embodiment as described in this disclosure. The messages are either data or data flag when the remote unit is ready to transmit a bar code message to the base station. Polling messages from the receiver 128 constitute received polling data and are also inputted into the control unit 120. The receiver outputs a valid signal (a level which may be one polarity rather than another or ground) to the computer 120 when the strength of the received signal is sufficient (amplitude and duration) to distinguish it from noise. The received data is not utilized without the valid signal output being of proper level. The control unit 120 provides data or flag data message response to the modulator 132. It operates the T/R switch 133 to a transmit position so that the response message can be transmitted to the base station.

The base station also provides polling messages addressed to the remote unit to acknowledge the receipt of valid data messages. Finally, the control unit 120 operates an annunciator 136, which may include an audible signal generator and speaker 138 and a data received indicator LED (light emitting diode) 140. In this embodiment, the directional antenna 44 provides greater communication distance or a reduction in “multi-path” interference for greater reliability.

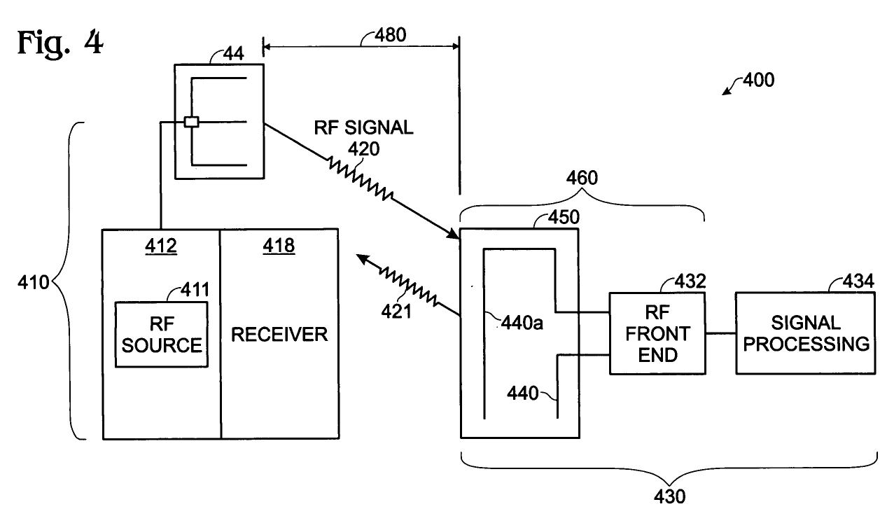

FIG. 4 is a block diagram showing a system 400 with a transmitter or base station 410 communicating an RF signal 420 to any general receiver 430. As is well know by the practitioner in the art, system 400 may be used in connection with a multiple technology data reader 200 (FIG. 3) when there is a need for RF wireless transmission.

Block 410 is any radio frequency transmitter/responder that is well known in the art. The transmitter includes an RF source 411 and RF amplifier 412 that sends RF power to the transmitter (first) loop antenna means 44 (FIG. 5). The transmitter 410 may also have an optional receiver station 418 for two-way communication with the receiver/tag 430. The transmitter 410 transmits an RF signal 420 with a transmitter carrier signal. The transmitter carrier also has a bandwidth that is wide enough to transmit data at a desired rate.

The receiver 430 in an embodiment of the invention is an RFID tag comprising a dipole antenna 450, and RF processing section that further includes the front end 432 and a signal processing section 434. The dipole antenna 450 that includes a first element 440, a second element 440a and front end 432, make up the antenna/front end combination 460. Alternately, a second loop antenna means 44 (FIG. 5) is substitutable for the dipole antenna 450.

The front end 432 may be any known front end design used with an antenna. Typically, in RFID applications using passive tags, the front end 432 converts the electromagnetic field 420 into a direct current (DC) voltage. The DC voltage supplies the power required to operate the signal processing component 434 of the RFID circuit (432 and 434 inclusive). Furthermore, the front end 432 extracts the envelope of the modulated signal from the electromagnetic field 420. The electromagnetic field 420 produces a DC voltage, which is large enough to power the tag circuitry to generate the RFID identification signal. This identification signal is in the form of a back scattered electromagnetic field 421 to transmit information to the base station 410. The required DC voltage is determined by the requirements to operate the front end 432 and signal processing 434 a given distance 480 from the transmitter 410.

The loop directional antenna 44, as shown in FIGS. 5A and 5B, are a polarized antenna arrangement in the preferred embodiment of the invention. The polarized antenna 44 includes a first element 44a, in communication with a second element 44b, in communication with a third element 44c and in communication with a fourth element 44d. The elements 44a, 44b, 44c and 44d communicate in such a way as to form a square or loop. The combination of these elements creates a desired field distribution. If location 44e is driven, the radiated field is horizontally polarized. Likewise, when location 44f is driven, the radiated field is vertically polarized. Depending on a design, numerous field distributions are attainable by the use of differing lengths of each element, and by changing the location that is driven in a “grounded plane.” The loop directional antenna 44 uses the plane 44g as “ground plane.” The loop directional antenna 44 uses a connector 44h to connect elements 44a, 44d, 44c and 44d with the interrogator (not shown).

For example, the second element 44b and the fourth element 44c can be about from ⅛ to ¼ wavelengths from the first element 44a and third element 44c, at the highest frequency of operation and supplied with equal in-phase current. Such an array would be multi-directional and provide increased broadside gain. Alternately, it is possible to produce a unidirectional pattern by feeding the elements 44a and 44c, and elements 44b and 44d with a phase difference of 90 degrees by means of an electrical ¼ wavelength delay line. This arrangement produces a broad single lobe (cardioid pattern) in the direction of the element with lagging current and improved radiation. However, the radiation resistance and the feed point resistance will be lower than for ¼ wavelength combined elements 44a, 44b, 44c and 44d, making the system more sensitive with respect to operating bandwidth and impedance matching. Similarly, elements 44a, 44b, 44c and 44d can with different lengths result in different radiation patterns.

The directivity or gain of a loop antenna 44 is the ratio of the maximum value of the power radiated per unit solid angle to the average power radiated per unit solid angle:
G=(dP/dΩ)max/P/4Π (1)
Thus, the directivity measures how much more intensely the antenna radiates than an isotropic radiator would when fed with the same total power.

The loop antenna 44 can be used to receive and to emit electromagnetic radiation. The incoming wave induces a voltage in the loop antenna 44, which can be detected in an electrical circuit connected to the antenna. This process is equivalent to the emission of electromagnetic waves by the antenna in reverse. As an electrical circuit, a receiving loop antenna 44 is represented as an electro motive force (EMF) connected in series with a resistor (not shown). The EMF, V₀*cos wt, represents the voltage reduced in the incoming wave and according to Ohm's Law:
V₀*cos wt=I₀*cos wt(R_{rad}+R_{load}) (2)
When I=I₀*cos wt, the power input to the circuit is:
Pᵢₙ=V₀²/2(R_{rad}+R_{load}) (3)
The power input to the circuit is:
P_{load}=R_{load}*V₀²/2(R_{rad}+R_{load})² (4)
The power re-radiated by the antenna is:
P_{rad}=R_{rad}*V₀²/2(R_{rad}+R_{load})² (5)
In the design of antennas, Pᵢₙ=P_{load}+P_{rad}, thus the maximum power transfer to the load occurs when ∂P_{load}/∂R_{load}=0.

In the present embodiment, the loop antenna 44 radiation resistance must match the resistance of the load circuit (not shown) for a maximum transfer rate at a given bandwidth. In other words:
P_{load}=P_{rad}=V₀²/8R_{rad}=Pᵢₙ/2 (6)

FIG. 6 shows a preferred embodiment. In the system, a bar code scanner 310 is used to scan a bar code 320. Once the bar code scanner 310 has successfully scanned the bar code 320, the raw bar code data is digitized and stored in a memory 330 internal to the bar code scanner 310. The return data, which corresponds to light reflected off of the bar code symbol, is received by a photodiode detector 380 and then the raw data is sent to a digitizer 390. The digitized data is then stored in a memory 330. A loop antenna 44 (FIG. 5) is used to send modulated data to a computer 340. Other embodiments that can use antenna 44 are described in U.S. Pat. No. 6,024,284, issued to Schmid et al., entitled “Wireless Bar Code Scanning System,” the entire contents of said patent are incorporated herein by reference and made part of this disclosure. This scanner may use the principles of the preferred embodiment as described in this disclosure.

When desired, the data is retrieved from the memory 330 modulated by modulator 395. The data is sent via a loop antenna 44 (FIG. 5) to a computer 340 which is located separate from the bar code scanner 310. The “when desired” may correspond to a particular time frame which the computer 340 is in a receiving mode. For example, such as a particular time division multiple access (TDMA) time slot. Alternately, the digitized data may be immediately sent out to the computer 340 as soon as it is digitized by the digitizer 380, wherein memory 330 is not needed. A control unit 399 at the bar code scanner 310 provides control of the wireless transmission or reception of data to the computer 340.

The means of wireless transmission may be by radio frequency signals, ultraviolet signals, infrared signals or ultrasonic transmission. The data may be sent via data packets or continuous streams of data, depending upon the amount of transmission signal processing which is done at the bar code scanner 310. In addition, the data could be subject to forward error correction (FEC), via an FEC encoder (not shown) resident in the bar code scanner 310. One such bar code scanner that can be utilized with the present invention is described in U.S. Pat. No. 5,665,956, issued to La et al., entitled “Bar Code Reading And Data Collection Unit With Ultrasonic Wireless Data Transmission,” the entire contents of said patent are incorporated herein by reference and made part of this disclosure. This reader may use the principles of the preferred embodiment as described in this disclosure.

While there has been illustrated and described a disclosure with reference to certain embodiments, it will be appreciated that numerous changes and modifications are likely to occur to those skilled in the art. It is intended in the appended claims to cover all those changes and modifications that fall within the spirit and scope of this disclosure and should, therefore, be determined only by the following claims and their equivalents.

What is claimed is:

1. A data reader comprising:
a) a housing;
b) a radio frequency identification (RFID) interrogator within said housing for detecting data;
c) processing circuitry connected to an output of said RFID interrogator;
d) a communications unit connected to said output; and
e) a loop antenna means connected to said communication unit for providing gain and directionality when transmitting and receiving an electromagnetic signal.

2. The data reader as claimed in claim 1, wherein the first, second, third and fourth elements of said loop antenna means has a plurality of lengths.

3. The data reader as claimed in claim 1, wherein the driven element orientation relative to the reflector of said loop antenna means has a plurality of positions.

4. A multiple technology data reader comprising:
a) an optical data reader comprising
a housing;
at least one photosensitive detector within said housing;
an optical collector for directing light onto said photosensitive detector; and
processing circuitry connected to an output of said photosensitive detector;
b) a radio frequency identification (RFID) interrogator for detecting data;
c) a communications unit connected to said optical data reader and said RFID interrogator; and
d) a loop antenna means connected to said communication unit for providing gain and directionality when transmitting and receiving an electromagnetic signal.

5. The data reader as claimed in claim 4, wherein the first, second, third and fourth elements of said loop antenna means has a plurality of lengths.

6. The data reader as claimed in claim 4, wherein the driven element orientation relative to the reflector of said loop antenna means has a plurality of positions.

7. The data reader as claimed in claim 4, wherein said detector, said optical collector, said processing circuitry, said RFID interrogator, said communication unit and said loop antenna are all within said housing.

8. A bar code scanning and decoding apparatus comprising;
a) a bar code scanner which includes,
a scanner configured to scan a bar code symbol;
a transmitter configured to transmit a signal corresponding to the scanned bar code symbol via wireless transmissions; and
a storage unit, wherein the scanner retains the signal in the storage unit until the acknowledgement signal is received from the computer;
b) a loop antenna means connected to said communication unit for providing gain and directionality when transmitting and receiving an electromagnetic signal; and
c) a computer separate from the bar code scanner, the computer including,
a receiver configured to receive the signal sent from the bar code scanner and to convert the signal to digital information; and
a computer program configured to receive the digital information from the receiver and to be executed by the computer based on the digital information,
wherein the computer sends an acknowledgement signal to the scanner when the computer has successfully received the signal,
wherein the computer receives the signal sent from the the bar code scanner in a time division manner, and
wherein the signal is allowed to be erased or overwritten in the storage unit once the acknowledgement signal is received from the computer.

9. The bar code scanning and decoding apparatus as claimed in claim 8, wherein the first, second, third and fourth elements of said loop antenna means has a plurality of lengths.

10. The bar code scanning and decoding apparatus as claimed in claim 8, wherein the driven element orientation relative to the reflector of said loop antenna means has a plurality of positions.

11. The bar code scanning and decoding apparatus as claimed in claim 8, wherein said bar code scanner and said loop antenna are all within a housing.

12. A multiple technology data reader comprising:
a) an optical data reader comprising
a housing;
at least one photosensitive detector within said housing;
an optical collector for directing light onto said photosensitive detector; and
processing circuitry connected to an output of said photosensitive detector;
b) a radio frequency identification (RFID) interrogator for detecting data;
c) a first loop antenna means to transmit the RFID signal and to receive the response from the transponder;
d) a communications unit connected to said optical data reader and said RFID interrogator; and
e) a second loop antenna means connected to said communication unit for providing gain and directionality when transmitting and receiving an electromagnetic signal.

13. The data reader as claimed in claim 12, wherein the first, second, third and fourth elements of said first and second loop antenna means has a plurality of lengths.

14. The data reader as claimed in claim 12, wherein the driven element orientation relative to the reflector of said first and second loop antenna means has a plurality of positions.

15. The data reader as claimed in claim 12, wherein said detector, said optical collector, said processing circuitry, said RFID interrogator, said first loop antenna means, said communication unit and said second loop antenna means are all within said housing.
